(19) United States
(12) Patent Application Publication
(10) Pub. No.: US 2013/0042470 A1
(43) Pub. Date: Feb. 21, 2013

(54) EXTRACTION TOOL

(71) Applicants: Michael J. Murphy, East Greenwich, RI (US); Glenn Goodman, Cumberland, RI (US)

(72) Inventors: Michael J. Murphy, East Greenwich, RI (US); Glenn Goodman, Cumberland, RI (US)

(73) Assignee: Advanced Interconnections Corp., West Warwick, RI (US)

(21) Appl. No.: 13/209,664

(22) Filed: Aug. 15, 2011

(51) Int. Cl. H01R 43/22

(52) U.S. Cl. 29/764

(57) ABSTRACT

An extracting tool for extracting an adapter from a socket includes an elongate body having a first linear portion arranged to extend along a first longitudinal axis, and a second linear portion arranged to extend along a second longitudinal axis, the second longitudinal axis extending in a direction transverse to the first longitudinal axis. The body further includes an intermediate portion disposed between the first linear portion and the second linear portion. At least a portion of the intermediate portion is non-coaxial with the first longitudinal axis and the second longitudinal axis. The second linear portion is offset relative to the first linear portion in a direction transverse to the first longitudinal axis, and includes a protrusion configured to engage the socket and/or adapter.

### BACKGROUND OF THE INVENTION

In some cases, an IC package may be indirectly secured to a substrate such as printed circuit board using an intercoupling device. The intercoupling device includes an adapter which electrically connects to, and is separable from, a socket. The adapter connects to the IC chip and provides electrical connections to the electrical contact regions of the IC chip, and the socket connects to the substrate, provides electrical connections to the electrical contact regions of the substrate. The intercoupling device advantageously permits the IC package to be easily secured to, and/or removed from, the substrate.

However, in order to prolong service life and improve function, electronic devices including IC packages frequently include peripheral cooling components such as heat sinks and/or fans to increase the surface area which dissipates heat generated by the device and speed up the transfer of heat to the air. In some devices, the cooling components are much larger than the electronic devices themselves. In these cases, the size and shape of the cooling components can make it difficult to access the intercoupling device to effect release of the IC package from the substrate.

### SUMMARY

In some aspects, a device is provided for extracting an adapter from a socket. The device includes a first linear portion arranged to extend along a first longitudinal axis, and a second linear portion arranged to extend along a second longitudinal axis, the second longitudinal axis extending at an angle relative to the first longitudinal axis. The second linear portion includes a distal end configured to be received by at least one of the adapter and socket. In addition, an intermediate portion is disposed between the first linear portion and the second linear portion, and at least a portion of the intermediate portion is non-coaxial with the first longitudinal axis and the second longitudinal axis. The second linear portion is offset relative to the first linear portion in a direction transverse to the first longitudinal axis.

The device may include one or more of the following features. The second linear portion is offset relative to the first linear portion in a direction parallel to the first longitudinal axis. The intermediate portion is linear and is angled relative to both the first longitudinal axis and the second longitudinal axis. The intermediate portion is disposed at an angle of 135 degrees relative to the first longitudinal axis. The device further comprises an adapter-facing side and an opposed side, and the intermediate portion is inclined toward the adapter-facing side. The device further comprises a protrusion extending from the second linear portion in a direction parallel to the second longitudinal axis. The protrusion is generally rectangular in shape including a first long edge, and a second long edge that is spaced apart from the first long edge, wherein the corners intersecting the first long edge are rounded using a first radius, and the corners intersecting the second long edge are rounded using a second radius, the second radius being greater than the first radius. The protrusion is generally rectangular in shape, including a first long edge, a second long edge that is spaced apart from the first long edge, and a pair of short edges connecting the first long edge to the second long edge. The protrusion includes planar surface, and a curved surface that is opposed to the planar surface. The device further includes a handle disposed on the first linear portion. The first linear portion has a length that is at least five times a length of the second linear portion. The first linear portion has a length that is at least three times a length of the intermediate portion.

In some aspects, a device is provided for extracting an adapter from a socket. The device includes a handle portion arranged to extend along a first longitudinal axis, and a leveraging portion arranged to extend along a second longitudinal axis, the second longitudinal axis extending at an angle relative to the first longitudinal axis, the leveraging portion including a distal end configured to be received by at least one of the adapter and socket. An intermediate portion is disposed between the handle portion and the leveraging portion, and at least a portion of the intermediate portion is non-coaxial with the first longitudinal axis and the second longitudinal axis. In addition, the leveraging portion is offset relative to the handle portion in a direction transverse to the first longitudinal axis.

The device may include one or more of the following features. The leveraging portion is offset relative to the handle portion in a direction parallel to the first longitudinal axis. The intermediate portion is linear and is angled relative to both the first longitudinal axis and the second longitudinal axis. The intermediate portion is disposed at an angle of 135 degrees relative to the first longitudinal axis. The device further comprises an adapter-facing side and an opposed side, and the intermediate portion is inclined toward the adapter-facing side. The device further comprises a protrusion extending from the leveraging portion in a direction parallel to the second longitudinal axis. The protrusion is generally rectangular in shape including a first long edge, and a second long edge that is spaced apart from the first long edge, wherein the corners intersecting the first long edge are rounded using a first radius, and the corners intersecting the second long edge are rounded using a second radius, the second radius being greater than the first radius. The protrusion includes planar surface, and a curved surface that is opposed to the planar surface.

An extraction tool is provided that includes a handle portion and a leveraging portion that is offset from the handle portion in a direction transverse to a longitudinal axis of the handle portion. By providing a leveraging portion which is offset relative to the handle, the tool can be applied to the intercoupling device to safely and quickly separate the adapter from the socket while avoiding contact with the cooling component and other electronic components secured to the substrate in the vicinity of the IC package.

Modes for carrying out the present invention are explained below by reference to an embodiment of the present invention shown in the attached drawings. The above-mentioned object, other objects, characteristics and advantages of the present invention will become apparent from the detailed description of the embodiment of the invention presented below in conjunction with the attached drawings.

### BRIEF DESCRIPTION OF THE DRAWINGS

FIG. 1 is a front perspective view of an extraction tool.

FIG. 2 is an enlarge view of the distal end of the extraction tool of FIG. 1.

FIG. 3 is a left side view of the extraction tool of FIG. 1.

FIG. 4 is a right side view of the extraction tool of FIG. 1.

FIG. 5 is a front (adapter facing) side view of the extraction tool of FIG. 1.

FIG. 6 is a rear side view of the extraction tool of FIG. 1.

FIG. 7 illustrates the extraction tool of FIG. 1 inserted in a corresponding slot formed in an intercoupling device.

FIG. 8 illustrates the separation of the adapter from the socket due to a lateral rocking motion of the extraction tool of FIG. 1 within the slot.

### DETAILED DESCRIPTION

Referring now to FIGS. 1-6, an extraction tool 100 is illustrated that is used to remove an IC package 2 from a substrate. More particularly, the extraction tool 100 is used to separate the mating components (e.g. an adapter 8 and a socket 12) of an intercoupling device 6 that is used to detachably secure an IC package 2 to a substrate such a printed circuit board, while avoiding contact with surrounding components connected to the printed circuit board in the vicinity of the intercoupling device. The extraction tool 100 is elongated, and includes a first linear portion 102, a second linear portion 118, and an intermediate portion 110 which extends between an end of the first linear portion 102 and an end of the second linear portion 118.

In the illustrated embodiment, the first linear portion 102, the second linear portion 118 and the intermediate portion 110 are formed integrally from a single piece of material having a rectangular cross-sectional shape. The extraction tool 100 also includes an adapter-facing side 126 and an opposed outward-facing side 128. The adapter-facing side 126 and the outward-facing side 128 are joined by side edges 130, 132 that are relatively short compared to the dimensions of the adapter-facing side 126 and the outward-facing side 128.

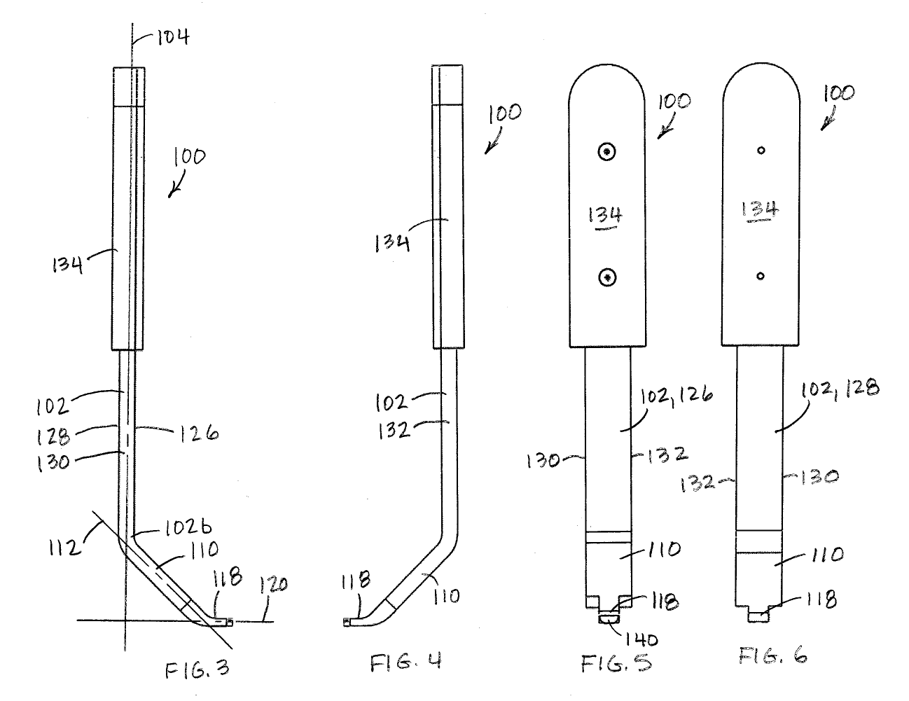

Referring particularly to FIGS. 3 and 4, the first linear portion 102 is arranged to extend along a first longitudinal axis 104, and is relatively long when compared to the intermediate portion 110 and second portion 118. For example, in the illustrated embodiment, the first linear portion 102 has a length that is at least five times a length of the second linear portion 118, and that is at least three times the length of the intermediate portion 110. The second linear portion 118 is arranged to extend along a second longitudinal axis 120 that extends in a direction transverse to the first longitudinal axis 104. The length of the second linear portion 118 is relatively short when compared to the first linear portion 102 and intermediate portion 110.

The intermediate portion 110 joins the first linear portion 102 to the second linear portion 118. At least a portion of the intermediate portion 110 is non-coaxial with the first longitudinal axis 104 and the second longitudinal axis 120. For example, in the illustrated embodiment, the intermediate portion 110 is linear, and is arranged to extend along an intermediate longitudinal axis 112 that is angled relative to both the first longitudinal axis 104 and the second longitudinal axis 120. As a result, the intermediate portion 110 is inclined toward the adapter-facing side 126. In this example, the intermediate portion 110 is disposed at an angle of 135 degrees relative to the first longitudinal axis 104. Because the intermediate portion 110 is angled, the second linear portion 118 is offset to one side of the first linear portion 102 in a direction transverse to the first longitudinal axis 104, and is also offset beyond the corresponding end 102b of the first linear portion 102 in a direction along the first longitudinal axis 104.

It will be understood that the intermediate portion 110 is not limited to this configuration, and can have any configuration which results in the second portion being offset relative to the first portion. In some embodiments, the intermediate portion 110 is shaped to accommodate the structure, particularly the profile, of the intercoupling device, IC package, IC package cooling structure and/or other components positioned on the substrate adjacent to these devices. For example, in an alternative embodiment, the intermediate portion could be in the form of a smooth curve that extends between and connects the first linear portion 102 and the second linear portion 118. In another example, the intermediate portion could have a serpentine configuration while connecting the first linear portion 102 and the second linear portion 118.

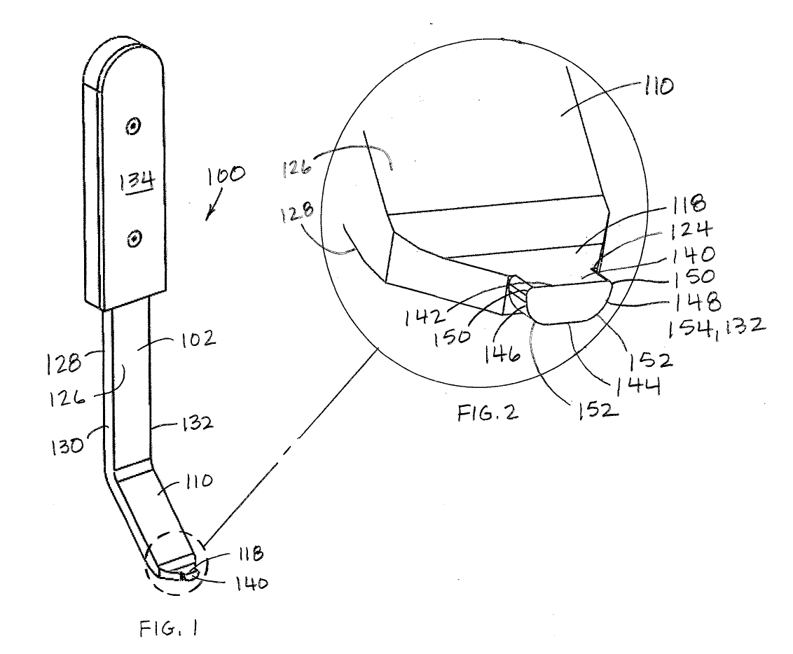

Referring to FIG. 2, the extraction tool 100 also includes a protrusion 140 that extends from the free end 124 of the second linear portion 118. In particular, the protrusion 140 extends in a direction parallel to the second longitudinal axis 120. The protrusion 140 is generally rectangular in cross-sectional shape including a first long edge 142 corresponding to the adapter-facing side 126, a second long edge 144 corresponding to the outward-facing side 128. Opposed ends of the first and second long edges 142, 144 are joined by respective short edges 146, 148. In addition, the corners 150 intersecting the first long edge 142 are rounded using a first radius, and the corners 152 intersecting the second long edge 144 are rounded using a second radius, and the second radius is greater than the first radius. The spacing between the respective short edges 146, 148 defines a width of the protrusion 140. The width of the protrusion 140 is less than the width of the second linear portion 118, and the second linear portion free end 124 tapers to the protrusion 140. The spacing between the first and second long edges 142, 144 defines a height of the protrusion 140, which is the same as the height of the second linear portion 118.

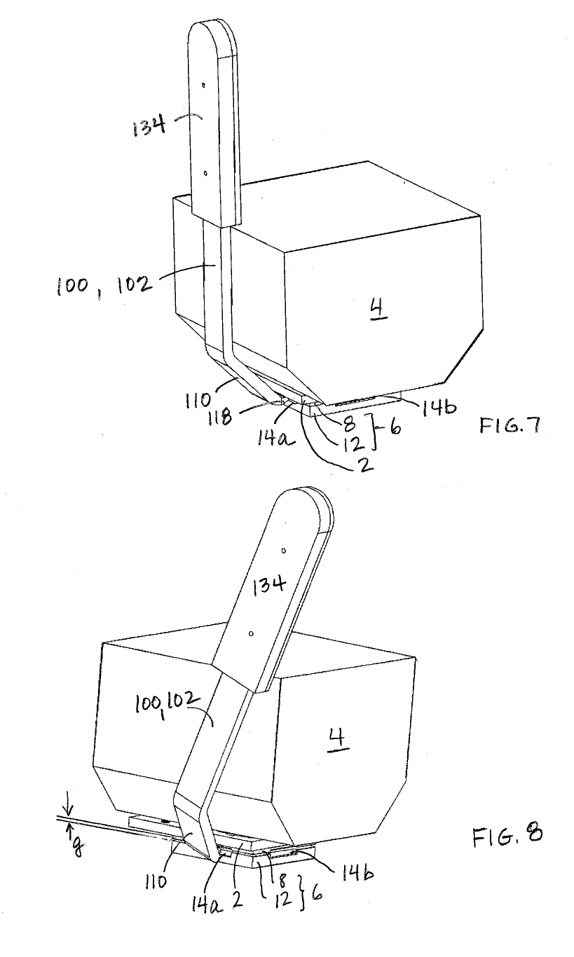

Referring to FIGS. 5 and 6, the extraction tool 100 includes a handle 134 disposed on the free end of the first linear portion 102. Although the handle 134 may be formed integrally with the first linear portion 102, in the illustrated embodiment, the handle 134 is formed separately and is secured to the first linear portion 102.

Referring to FIGS. 7 and 8, in use, the extraction tool 100 is positioned along a side of an intercoupling device 6 so that the adapter-facing side faces the IC package 2 and intercoupling device 6. In this position, the angled shape of the extraction tool 100 permits the tool 100 to generally conform to a peripheral shape of the IC package 2 and the cooling component 4 disposed on an outer surface of the IC package 2. Since the tool generally conforms to the peripheral shape of the IC package 2 and cooling component 4, the extraction tool 100 does not interfere or impinge upon other electrical components connected to the substrate in the vicinity of the IC package 2, including those which are adjacent to the IC package 2 and at least partially underlie the cooling component 4.

Each side of the intercoupling device 6 is provided with a slot 14 formed at the intersection of the adapter 8 and socket 12. The extraction tool 100 is positioned adjacent the IC package so that the protrusion 140 is inserted into a slot 14a formed in a first side of the intercoupling device 6. The slot width is generally much longer than that of the protrusion 140 to optimize accessability of the slot when working around other electrical components in the vicinity. In addition, the slot height is greater than the height of the protrusion, and is less than the width of the protrusion 140. In use, the extraction tool 100 is rotated about the second longitudinal axis 120 while the protrusion 140 is inserted in the slot 14. Due to the dimensional differences between the height of the slot 14a and the width of the protrusion 140, rotation of the tool 100 causes the corresponding edge of the adapter 8 to be urged apart from that of the socket 12. The separation is relatively small, corresponding to a gap g. The extraction tool 100 is then moved to an adjacent side of the intercoupling device, the protrusion 140 is inserted in a second slot 14b, and the extraction tool 100 is again rotated about the second longitudinal axis 120 so as to separate the corresponding edges of the adapter 8 and socket 12. The process is repeated on all sides of the intercoupling component 6, until the adapter 8 is completely separated from the socket 12. By leveraging apart each side of the intercoupling device 6 individually, the extraction tool 100 permits the IC package to be removed from the socket without damage to itself and/or to surrounding electrical components.

Although the extraction tool 100 is illustrated as being formed of a single piece of material, it is understood that the tool may be formed of two or more individual components that are joined in the desired configuration. In addition, although the extraction tool 100 is illustrated has having a rectangular cross-sectional shape, it is understood that the tool is not limited to this shape, but instead may be formed having other sectional shapes including oval, channel or tubular.

Although the second linear portion 118 is described as being arranged so as to extend along a second longitudinal axis 120 that extends in a direction transverse to the first longitudinal axis 104, is understood that the first and second longitudinal axes 104, 120 are not limited to this relative configuration. In particular, it is understood that the second longitudinal axis extends at an angle relative to the first longitudinal axis, where the angle may be acute, 90 degrees (as illustrated), or obtuse.

A selected illustrative embodiment of the invention is described above in some detail. It should be understood that only structures considered necessary for clarifying the present invention have been described herein. Other conventional structures, and those of ancillary and auxiliary components of the system, are assumed to be known and understood by those skilled in the art. Moreover, while a working example of the present invention has been described above, the present invention is not limited to the working example described above, but various design alterations may be carried out without departing from the present invention as set forth in the claims.

1. A device for extracting an adapter from a socket, the device comprising
a first linear portion arranged to extend along a first longitudinal axis, and
a second linear portion arranged to extend along a second longitudinal axis, the second longitudinal axis extending at an angle relative to the first longitudinal axis, the second linear portion including a distal end configured to be received by at least one of the adapter and socket, and
an intermediate portion having a third longitudinal axis, the intermediate portion disposed between the first linear portion and the second linear portion,
wherein the second linear portion is offset relative to the first linear portion in a direction transverse to the first longitudinal axis, and
the first longitudinal axis, the second longitudinal axis and the third longitudinal axis are coplanar.

2. The device of claim 1, wherein the second linear portion is offset relative to the first linear portion in a direction parallel to the first longitudinal axis.

3. The device of claim 1 wherein the intermediate portion is linear and is angled relative to both the first longitudinal axis and the second longitudinal axis.

4. The device of claim 1 wherein the intermediate portion is disposed at an angle of 135 degrees relative to the first longitudinal axis.

5. The device of claim 1 wherein the device further comprises an adapter-facing side and an opposed side, and the intermediate portion is inclined toward the adapter-facing side.

6. The device of claim 1 wherein the device further comprises a protrusion extending from the second linear portion in a direction parallel to the second longitudinal axis.

7. The device of claim 6 wherein the protrusion is generally rectangular in shape including a first long edge, and a second long edge that is spaced apart from the first long edge, wherein the corners intersecting the first long edge are rounded using a first radius, and the corners intersecting the second long edge are rounded using a second radius, the second radius being greater than the first radius.

8. The device of claim 6 wherein the protrusion is generally rectangular in shape, including a first long edge, a second long edge that is spaced apart from the first long edge, and a pair of short edges connecting the first long edge to the second long edge.

9. The device of claim 6 wherein the protrusion includes planar surface, and a curved surface that is opposed to the planar surface.

10. The device of claim 1 wherein the device further includes a handle disposed on the first linear portion.

11. The device of claim 1 wherein the first linear portion has a length that is at least five times a length of the second linear portion.

12. The device of claim 1 wherein the first linear portion has a length that is at least three times a length of the intermediate portion.

13. A device for extracting an adapter from a socket, the device comprising
a handle portion arranged to extend along a first longitudinal axis, and
a leveraging portion arranged to extend along a second longitudinal axis, the second longitudinal axis extending at an angle relative to the first longitudinal axis, the leveraging portion including a distal end configured to be received by at least one of the adapter and socket, and
an intermediate portion having a third longitudinal axis, the intermediate portion disposed between the handle portion and the leveraging portion,
wherein the leveraging portion is offset relative to the handle portion in a direction transverse to the first longitudinal axis, and
the first longitudinal axis, the second longitudinal axis and third longitudinal axis are coplanar.

14. The device of claim 13, wherein the leveraging portion is offset relative to the handle portion in a direction parallel to the first longitudinal axis.

15. The device of claim 13 wherein the intermediate portion is linear and is angled relative to both the first longitudinal axis and the second longitudinal axis.

16. The device of claim 13 wherein the intermediate portion is disposed at an angle of 135 degrees relative to the first longitudinal axis.

17. The device of claim 13 wherein the device further comprises an adapter-facing side and an opposed side, and the intermediate portion is inclined toward the adapter-facing side.

18. The device of claim 13 wherein the device further comprises a protrusion extending from the leveraging portion in a direction parallel to the second longitudinal axis.

19. The device of claim 18 wherein the protrusion is generally rectangular in shape including a first long edge, and a second long edge that is spaced apart from the first long edge, wherein the corners intersecting the first long edge are rounded using a first radius, and the corners intersecting the second long edge are rounded using a second radius, the second radius being greater than the first radius.

20. The device of claim 18 wherein the protrusion includes planar surface, and a curved surface that is opposed to the planar surface.

21. The device of claim 1 wherein the intermediate portion is angled relative to the first longitudinal axis in a direction toward the distal end of the second linear portion.

22. The device of claim 13 wherein the intermediate portion is angled relative to the first longitudinal axis in a direction toward the distal end of the leveraging portion.
